(19) United States
(12) Patent Application Publication
(10) Pub. No.: US 2025/0216554 A1
(43) Pub. Date: Jul. 3, 2025

(54) System and Method for Automatically Monitoring Surface Roughness of a Field During an Agricultural Operation

(71) Applicant: CNH Industrial America LLC, New Holland, PA (US)

(72) Inventors: Wenan Yuan, Willowbrook, IL (US); Brittany Schroeder, Bunker Hill, IN (US)

(21) Appl. No.: 18/398,321

(22) Filed: Dec. 28, 2023

(51) Int. Cl. G01S 17/894; A01B 63/00; A01B 79/00

(52) U.S. Cl. CPC G01S 17/894; A01B 63/002; A01B 79/005

(57) ABSTRACT

An agricultural system includes a sensor having a field of view directed toward a portion of the field worked by an agricultural implement during an agricultural operation. The agricultural system further includes a computing system that receives data generated by the sensor, with the data including a plurality of points. The computing system filters the data to remove points indicative of dust from remaining points of the plurality of points and rotates the data such that a surface of the field determined from the remaining points is substantially horizontal. Additionally, the computing system sub-divides the data into subsections after rotating, determines both a high point and a low point within each of the subsections, then determines a surface roughness of the field based at least in part on the high point and the low point within each of the subsections.

### FIELD OF THE INVENTION

The present subject matter relates generally to performing agricultural operations using work vehicles and/or associated implements and, more particularly, to a system and method for automatically monitoring the surface roughness of a field during the performance of an agricultural operation.

### BACKGROUND OF THE INVENTION

It is well known that, to attain the best agricultural performance from a field, a farmer must cultivate the soil, typically through a tillage operation. Tillage implements typically include a plurality of ground engaging tools configured to engage the soil as the implement is moved across the field. Such ground engaging tools loosen and/or otherwise agitate the soil to a certain depth in the field to prepare the field for subsequent agricultural operations, such as planting operations.

When performing a tillage operation, it is desirable to create a level and uniform layer of tilled soil across the field for a proper seedbed in subsequent planting operations. Depending on the season, different surface finishes may be desired. For instance, rougher surfaces with more and/or larger clods may be desired when tilling before wintering a field, as the surface will become smoother over winter and be ready for spring planting, whereas a smoother field may crust over during wintering, which requires another tillage pass before spring planting to break up the crust. However, the soil type or texture, the amount and distribution of crop residue, the moisture content, and/or the like may vary across a field, which requires an operator to constantly monitor the surface finish created during passes with the implement during the agricultural operation and make frequent adjustments to the implement to maintain the proper surface finish, which causes operator fatigue. Further, it may be difficult for an operator to see the field directly behind the implement if the implement is creating dust. If the proper surface finish is not maintained, additional passes in the field may be required, which increases costs and time, and may even reduce the yield of the next planting season within the field.

Accordingly, a system and method for automatically monitoring the soil surface roughness of a field during the performance of an agricultural operation would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural system for monitoring surface roughness within a field during an agricultural operation. The agricultural system may include an agricultural implement having at least one ground engaging tool, with the at least one ground engaging tool being configured to engage a field to perform an agricultural operation within the field as the agricultural implement moves across the field. Moreover, the agricultural system may include a sensor having a field of view directed toward a portion of the field worked by the agricultural implement during the agricultural operation, with the sensor being configured to generate data indicative of the portion of the field, where the data includes a plurality of points. Additionally, the agricultural system includes a computing system configured to receive the data generated by the sensor and filter the data to remove points indicative of dust from remaining points of the plurality of points. The computing system may further be configured to rotate the data after filtering such that a surface of the field determined from the remaining points is substantially horizontal. Moreover, the computing system may be configured to sub-divide the data into a plurality of subsections after rotating, then determine both a high point associated with a given high height-percentile and a low point associated with a given low height-percentile of the remaining points within each of the plurality of subsections, with the high height-percentile being higher than the given low height-percentile. Additionally, the computing system may be configured to determine a surface roughness of the field based at least in part on the high point and the low point within each of the plurality of subsections.

In another aspect, the present subject matter is directed to an agricultural method for monitoring surface roughness within a field during an agricultural operation with an agricultural implement having at least one ground engaging tool, with the at least one ground engaging tool being configured to engage the field to perform the agricultural operation as the agricultural implement moves across the field. The agricultural method may further include receiving, with a computing system, data generated by a sensor having a field of view directed toward a portion of the field worked by the agricultural implement during the agricultural operation, with the data being indicative of the portion of the field, and with the data including a plurality of points. The agricultural method may further include filtering, with the computing system, the data to remove points indicative of dust from remaining points of the plurality of points. Further, the agricultural method may include rotating, with the computing system, the data after filtering such that a surface of the field determined from the remaining points is substantially horizontal. Furthermore, the agricultural method may include sub-dividing, with the computing system, the data into a plurality of subsections after rotating, and determining, with the computing system, both a high point associated with a given high height-percentile and a low point associated with a given low height-percentile of the remaining points within each of the plurality of subsections, with the given high height-percentile being higher than the given low height-percentile. Moreover, the agricultural method may include determining, with the computing system, a surface roughness of the field based at least in part on the high point and the low point within each of the plurality of subsections. Additionally, the agricultural method may include performing, with the computing system, a control action associated with the agricultural implement based at least in part on the surface roughness of the field.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a tillage implement coupled to a work vehicle in accordance with aspects of the present subject matter;

FIG. 2 illustrates another perspective view of the implement, particularly illustrating various components of the implement, in accordance with aspects of the present subject matter;

FIG. 3 illustrates a schematic, top down view of the work vehicle and the implement shown in FIGS. 1 and 2, particularly illustrating various examples of locations for installing soil roughness sensors on the work vehicle and/or the implement;

FIG. 4 illustrates a schematic view of one embodiment of a system for automatically monitoring the soil surface roughness of a field during the performance an agricultural operation in accordance with aspects of the present subject matter;

FIG. 5 illustrates one embodiment of a flow diagram showing various data processing steps that may be performed when monitoring soil surface roughness in accordance with aspects of the present subject matter;

FIGS. 6A-6F illustrate various views of data during the data processing steps of FIG. 5 in accordance with aspects of the present subject matter; and

FIG. 7 illustrates a flow diagram of one embodiment of a method for automatically monitoring the soil surface roughness of a field during the performance of an agricultural operation in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for automatically monitoring the surface roughness of a field during the performance of an agricultural operation. Specifically, in several embodiments, one or more soil roughness sensors are provided in association with a work vehicle and/or an agricultural implement towed by the work vehicle to capture data indicative of a surface roughness of a field as an agricultural operation is being performed with the agricultural implement. The soil roughness sensors are non-contact sensors, spaced apart from a surface of the field, and configured to generate point-cloud data, including a plurality of points. For instance, the soil roughness sensors may be Light Detection and Ranging (LIDAR) sensors, and/or any other suitable type of sensor that generates, or is used to generate, a three-dimensional (3D) point cloud. It may be difficult to accurately estimate the soil roughness of the field from the data generated by the soil roughness sensors. For instance, the data generated by the soil roughness sensors may include both data indicative of the surface of the field as well as data indicative of anything between the sensor and the field, such as dust, soil clods, and/or the like. Moreover, depending on the orientation of the sensor relative to the field, it may be difficult to accurately estimate the magnitude of variations in the surface of the field.

As such, in accordance with aspects of the present subject matter, a data processing method is provided that filters the data generated by the soil roughness sensors to remove the data points indicative of objects (e.g., dust, soil clods, and/or the like) between the surface of the field and the sensors from remaining points of the data, before rotating the remaining points (if necessary) to account for the orientation of the sensor. After rotating, the remaining points are divided into a plurality of subsections, where both a high point and a low point are determined for each of the plurality of subsections. For instance, the high point of a given subsection may be associated with a high height-percentile of the heights of the remaining points in the subsection, such as a 95^{th}-100^{th} height-percentile, where the 100^{th} percentile is the highest point (closest to the sensor). Similarly, the low point of a given subsection may be associated with a low height-percentile of the heights of the remaining points in the subsection, such as a 0^{th}-5^{th} percentile, where the 0^{th} percentile is the lowest point (furthest from the sensor). Thereafter, a surface roughness of the field may be determined based at least in part on the high point and the low point within each of the plurality of subsections. Accordingly, the surface roughness of the field may be automatically and accurately determined. Additionally, in some instances, a control action may be automatically performed based at least in part on the surface roughness determined, which reduces operator fatigue and improves the performance of the implement, in turn, reducing costs and potentially improving yield of a subsequent harvest.

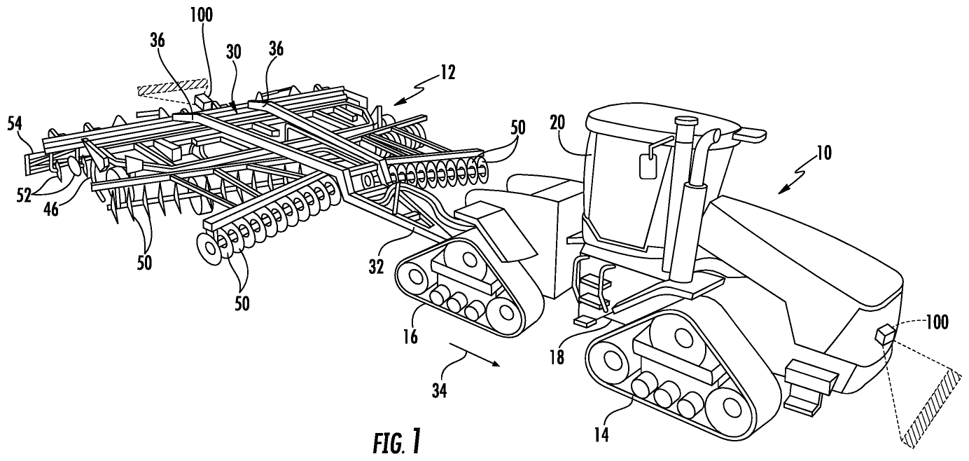

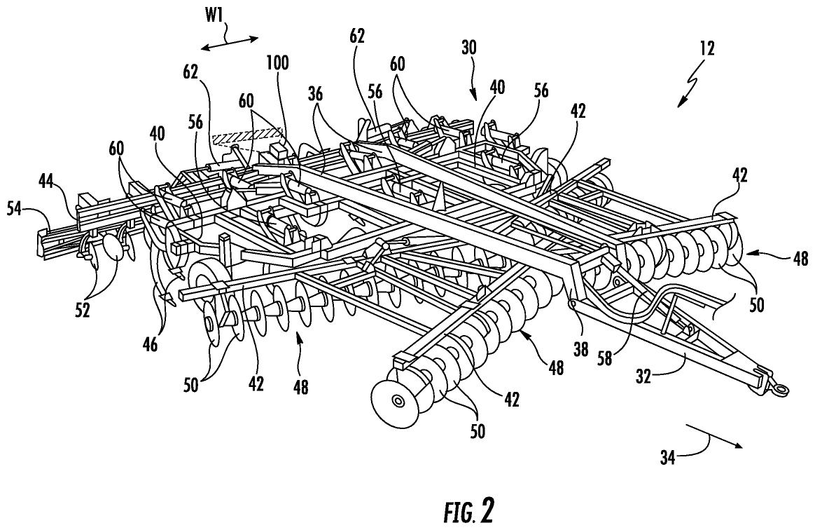

Referring now to drawings, FIGS. 1 and 2 illustrate perspective views of one embodiment of a work vehicle 10 and an associated implement 12 in accordance with aspects of the present subject matter. Specifically, FIG. 1 illustrates a perspective view of the work vehicle 10 towing the implement 12 (e.g., across a field). Additionally, FIG. 2 illustrates a perspective view of the implement 12 shown in FIG. 1. As shown in the illustrated embodiment, the work vehicle 10 is configured as an agricultural tractor and the implement 12 is configured as an associated tillage implement. However, in other embodiments, the work vehicle 10 may be configured as any other suitable agricultural vehicle and/or any other suitable type of work vehicle, such as a construction vehicle. Similarly, in other embodiments, the implement 12 may be configured as any other suitable agricultural implement and/or any other suitable type of implement configured to be towed by a work vehicle.

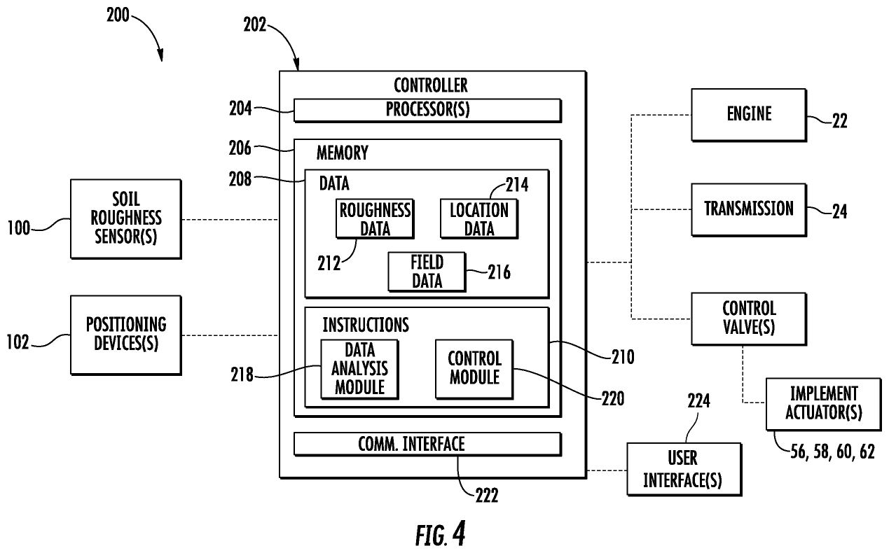

As particularly shown in FIG. 1, the work vehicle 10 includes a pair of front track assemblies 14, a pair or rear track assemblies 16 and a frame or chassis 18 coupled to and supported by the track assemblies 14, 16. An operator's cab 20 may be supported by a portion of the chassis 18 and may house various input devices (e.g., one or more user interfaces 224 (FIG. 4)) for permitting an operator to control the operation of one or more components of the work vehicle 10 and/or one or more components of the implement 12. Additionally, as is generally understood, the work vehicle 10 may include an engine 22 (FIG. 4) and a transmission 24 (FIG. 4) mounted on the chassis 18. The transmission 24 may be operably coupled to the engine 22 and may provide variably adjusted gear ratios for transferring engine power to the track assemblies 14, 16 via a drive axle assembly (not shown) (or via axles if multiple drive axles are employed).

Additionally, as shown in FIGS. 1 and 2, the implement 12 may generally include a carriage frame assembly 30 configured to be towed by the work vehicle via a pull hitch or tow bar 32 in a travel direction of the vehicle (e.g., as indicated by arrow 34). It should be understood that, in addition to being towed by the work vehicle 10, the implement 12 may also be a semi-mounted implement connected to the work vehicle 10 via a two point hitch (not shown) or the implement 12 may be a fully mounted implement (e.g., mounted the work vehicle's 10 three point hitch (not shown)). As particularly shown in FIG. 2, the carriage frame assembly 30 may include aft extending carrier frame members 36 coupled to the tow bar 32. In addition, reinforcing gusset plates 38 may be used to strengthen the connection between the tow bar 32 and the carrier frame members 36. In several embodiments, the carriage frame assembly 30 may generally function to support a central frame 40, a forward frame 42 positioned forward of the central frame 40 in the direction of travel 34 of the work vehicle 10, and an aft frame 44 positioned aft of the central frame 40 in the direction of travel 34 of the work vehicle 10.

As is generally understood, the carriage frame assembly 30 may be configured to support a plurality of ground-engaging tools, such as a plurality of shanks, disk blades, leveling blades, basket assemblies, tines, spikes, and/or the like, configured to perform a tillage operation or any other suitable agricultural operation across the field along which the implement 12 is being towed. For instance, as shown in FIG. 2, in one embodiment, the central frame 40 may correspond to a shank frame configured to support a plurality of ground-engaging shanks 46 configured to till or otherwise engage the soil as the implement 12 is towed across the field. Moreover, in one embodiment, the forward frame 42 may correspond to a disk frame configured to support various gangs or sets 48 of disk blades 50. In such an embodiment, each disk blade 50 may, for example, include both a concave side (not shown) and a convex side (not shown). In addition, the various gangs 48 of disk blades 50 may be oriented at an angle relative to the travel direction 34 of the work vehicle 10 to promote more effective tilling of the soil. Additionally, similar to the central and forward frames 40, 42, the aft frame 44 may be configured to support a plurality of leveling blades 52 and rolling (or crumbler) basket assemblies 54. However, in other embodiments, any other suitable ground-engaging tools may be additionally, or alternatively, coupled to and supported by the different frame sections 40, 42, 44. For instance, the aft frame 44 may additionally, or alternatively, support a plurality closing disks (not shown).

In addition, the implement 12 may also include any number of suitable actuators (e.g., hydraulic cylinders) for adjusting the relative positioning, penetration depth, and/or down force associated with the various ground-engaging tools 46, 50, 52, 54. For instance, the implement 12 may include one or more first actuators 56 coupled to the central frame 40 for raising or lowering the central frame 40 relative to the ground, thereby allowing the penetration depth and/or the down pressure of the shanks 46 to be adjusted. Similarly, the implement 12 may include one or more second actuators 58 coupled to the forward frame 42 to adjust the penetration depth and/or the down pressure of the disk blades 50. Moreover, the implement 12 may include one or more third actuators 60 coupled to the aft frame 44 to allow the aft frame 44 to be moved relative to the central frame 40, thereby allowing the relevant operating parameters of the ground-engaging tools 52, 54 supported by the aft frame 44 (e.g., the down pressure and/or the penetration depth) to be adjusted. Additionally, in some instances, the implement 12 may include one or more basket actuators 62 configured to allow the down pressure on the associated basket assembly(ies) 54 to be adjusted.

It should be appreciated that the configuration of the work vehicle 10 described above and shown in FIG. 1 is provided only to place the present subject matter in an exemplary field of use. Thus, it should be appreciated that the present subject matter may be readily adaptable to any manner of work vehicle configuration. For example, in an alternative embodiment, a separate frame or chassis may be provided to which the engine, transmission, and drive axle assembly are coupled, a configuration common in smaller tractors. Still other configurations may use an articulated chassis to steer the work vehicle 10 and/or rely on tires/wheels in lieu of the track assemblies 14, 16. It should further be appreciated that the configuration of the implement 12 described above and shown in FIGS. 1 and 2 is only provided for exemplary purposes. Thus, it should be appreciated that the present subject matter may be readily adaptable to any manner of implement configuration. For example, as indicated above, each frame section of the implement 12 may be configured to support any suitable type of ground-engaging tools, such as by installing any combination of shanks, disk blades, leveling blades, basket assemblies, tines, spikes, and/or the like on or more sections of the frame assembly 30. Alternatively, as opposed to the illustrated tillage implement, the implement 12 may be configured as a planting implement, a fertilizing implement and/or any other suitable type of agricultural implement.

Additionally, in accordance with aspects of the present subject matter, the work vehicle 10 and/or the implement 12 may include one or more soil roughness sensors 100 coupled thereto and/or supported thereon for monitoring the surface roughness of the field as an agricultural operation (e.g., a tillage operation, a planting operation, fertilizing operation, and/or the like) is being performed thereon via the implement 12. Specifically, in several embodiments, the soil roughness sensor(s) 100 may be non-contact sensors provided in operative association with the work vehicle 10 and/or the implement 12 such that the sensor(s) 100 is spaced apart from the surface of the field and has a field of view or sensor detection range directed towards a portion(s) of the field adjacent to the work vehicle 10 and/or the implement 12. As such, the soil roughness sensor(s) 100 may be used to detect the surface roughness of the adjacent portions of the field as the tractor 10 and/or implement 12 passes by such portions of the field during the performance of the agricultural operation.

In general, the soil roughness sensor(s) 100 may correspond to any suitable sensing device(s) configured to detect or capture data associated with the surface roughness of the soil. Particularly, the soil roughness sensor(s) 100 may be any suitable sensing device(s) configured to generate a 3D point-cloud having a plurality of points that may be used to determine the surface roughness of the field. For instance, in several embodiments, the soil roughness sensor(s) 100 may correspond to a Light Detection and Ranging (“LIDAR”) device(s), such as a LIDAR scanner(s). In such embodiments, the soil roughness sensor(s) 100 may be configured to output light pulses from a light source (e.g., a laser outputting a pulsed laser beam) and detect the reflection of each pulse off of the soil surface to generate a point-cloud. Based on the time of flight of the light pulses, the specific location (e.g., 3-D coordinates) of the soil surface relative to the sensor(s) 100 may be calculated. By scanning the pulsed light over a given swath width, the surface roughness of the soil may be detected across a given section of the field. Thus, by continuously scanning the pulsed light along the soil surface as the work vehicle 10 and the implement 12 are moved across the field, a 3D point cloud may be generated that includes surface roughness data for all or a portion of the field.

In another embodiment, the soil roughness sensor(s) 100 may correspond to a suitable camera(s) configured to capture three-dimensional images of the soil surface, thereby allowing the soil surface roughness to be calculated or estimated by analyzing the content of each image. For instance, in a particular embodiment, the soil roughness sensor(s) 100 may correspond to a stereographic camera(s) having two or more lenses with a separate image sensor for each lens to allow the camera(s) to capture stereographic or three-dimensional images. In a further embodiment, the soil roughness sensor(s) 100 may correspond to any other suitable sensing device(s) configured to detect or capture surface roughness data using a non-contact detection methodology, such as a radar device (e.g., a 3D radar device and/or 4D radar device) configured to emit radar waves and detect the reflection of such waves off of the soil surface to allow the surface roughness to be estimated.

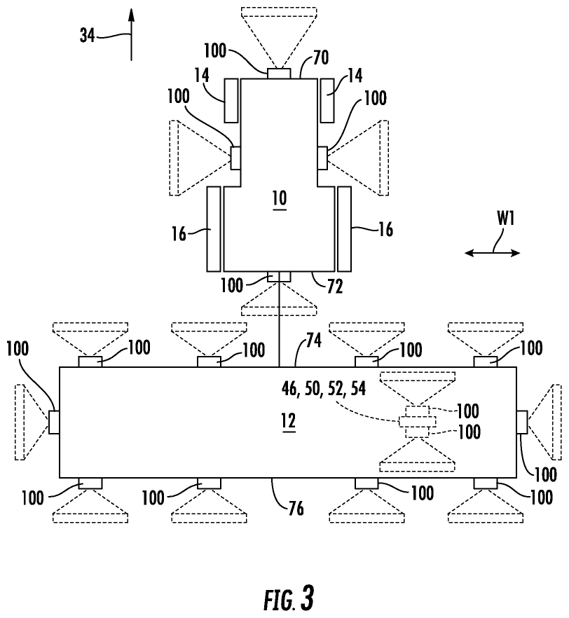

In several embodiments, two or more soil roughness sensors 100 may be provided in operative association with the work vehicle 10 and/or the implement 12. For instance, as shown in FIGS. 1 and 2, in one embodiment, a first soil roughness sensor 100 may be provided at a forward end 70 (FIG. 3) of the work vehicle 10 to allow the sensor 100 to capture data associated with the soil roughness of an adjacent first section of the field disposed in front of the work vehicle 10. For instance, for each detection event, the first soil roughness sensor 100 may be configured to capture soil roughness data along a plane or reference line that extends generally perpendicular to the travel direction 34 of the work vehicle 10 directly in front of the vehicle 10. Similarly, as shown in FIGS. 1 and 2, a second soil roughness sensor 100 may be provided at or adjacent to an aft end 76 (FIG. 3) of the implement 12 to allow the sensor 100 to capture data associated with the soil roughness of an adjacent second section of the field disposed behind the implement 12. For instance, for each detection event, the second soil roughness sensor 100 may be configured to capture soil roughness data along a plane or reference line that extends generally perpendicular to the travel direction 34 of the work vehicle 10 at a location directly behind the implement 12.

By capturing soil surface roughness data at a location forward of the ground engaging tools 46, 50, 52, 54 of the implement 12 (e.g., at the location detected by the first soil roughness sensor 100) and at a location aft of the ground engaging tools 46, 50, 52, 54 (e.g., at the location detected by the second soil roughness sensor 100) as the work vehicle 10 tows the implement 12 to allow an agricultural operation to be performed along a given section of the field, the sensors 100 may be used to collect data both before and after the performance of the agricultural operation. However, it should be appreciated that, in some instances, only the data indicative of the surface roughness of the portion of the field worked by the implement 12 is monitored. Moreover, it should be appreciated that the soil roughness sensor(s) 100 may be installed at any other suitable location(s) that allows the sensor(s) 100 to capture suitable surface roughness data.

For instance, FIG. 3 illustrates a schematic, top-down view of the work vehicle 10 and the implement 12 shown in FIGS. 1 and 2, particularly illustrating alternative sensor locations for the soil roughness sensor(s) 100. As shown, as alternative, or in addition, to positioning the soil roughness sensor 100 at the forward end 70 of the work vehicle 10 to generate data indicative of the surface roughness of the field before an agricultural operation with the implement 12, the soil roughness sensor(s) 100 may be positioned at any other suitable location forward of one or more of the ground engaging tools 46, 50 52, 54 of the implement 12 in the travel direction 34 of the work vehicle 10, such as at or adjacent to an aft end 72 of the work vehicle 10, at or adjacent to a forward end 74 of the implement 12, at or adjacent to one of the sides of the work vehicle 10, and/or at or adjacent to one of the sides of the implement 12. Similarly, as an alternative to positioning the soil roughness sensor(s) 100 at the aft end 76 of the implement 12 to generate data indicative of the surface roughness of the field after performing the agricultural operation with the implement 12, the soil roughness sensor(s) 100 may be positioned at any other suitable location aft of one or more of the ground engaging tools 45, 50, 52, 54 of the implement 12 in the travel direction 34 of the work vehicle 10. For instance, as shown in FIG. 3, the second soil roughness sensor(s) 100 may be positioned at a location immediately behind a given ground-engaging tool 46, 50, 52, 54 of the implement 12. In such an embodiment, another soil roughness sensor(s) 100 may, for example, be similarly positioned at a location immediately in front of the ground-engaging tool 46, 50, 52, 54 to allow data associated with the surface roughness of the soil to be captured immediately forward and aft of the ground-engaging tool 46, 50, 52, 54, thereby providing a means to assess or analyze the individual performance or effectiveness of the tool.

It should also be appreciated that, an array of soil roughness sensors 100 may be provided on the work vehicle 10 and/or the implement 12 such that the surface roughness of the field across a wider portion of the lateral width W1 of the implement 12 may be determined. For instance, as shown in FIG. 3, an array of soil roughness sensors 100 may be provided at or adjacent to the forward end 74 of the implement 12 to allow surface roughness data prior to the agricultural operation with the implement 12 to be captured across multiple portions of the field along the lateral width W1 of the implement 12. Similarly, as shown in FIG. 3, an array of soil roughness sensors 100 may be provided at or adjacent to the aft end 76 of the implement 12 to allow surface roughness data after the agricultural operation with the implement 12 to be captured across multiple portions of the field along the lateral width W1 of the implement 12. In some instances, the surface roughness may be monitored across an entire lateral width W1 of the implement 12.

Additionally, it should be appreciated that, although the embodiments shown in FIGS. 1-3 illustrate two or more soil roughness sensors 100 installed on the work vehicle 10 and/or the implement 12, a single roughness sensor may be installed relative to the work vehicle 10 and/or the implement 12 to allow surface roughness data for the field to be captured. For instance, in one embodiment, it may be desirable to only have a single soil roughness sensor that captures surface roughness data either before or after the agricultural operation is performed.

As will be described below, the data captured by the soil roughness sensors 100 may be analyzed by an associated computing system 202 (FIG. 4) to calculate or estimate a surface roughness for the field that provides an indication of the current effectiveness of the implement 12 in adjusting the surface roughness of the soil. Based on the estimated surface roughness, the computing system 202 may, for example, control/adjust the operation of the work vehicle 10 and/or the implement 12, as necessary, to ensure that the surface roughness is maintained at a given target value and/or within a given target range (e.g., an operating range defined around a target roughness desired for the specific agricultural operation being performed within the field).

Referring now to FIG. 4, a schematic view of one embodiment of a system 200 for automatically monitoring the soil surface roughness of a field during an agricultural operation within the field is illustrated in accordance with aspects of the present subject matter. In general, the system 200 will be described herein with reference to the work vehicle 10 and the implement 12 described above with reference to FIGS. 1-3. However, it should be appreciated that the disclosed system 200 may generally be utilized with work vehicles having any suitable vehicle configuration and/or implements having any suitable implement configuration.

In several embodiments, the system 200 may include a computing system 202 and various other components configured to be communicatively coupled to and/or controlled by the computing system 202, such as one or more soil roughness sensors 100, and/or various components of the work vehicle 10 and/or the implement 12, such as actuator(s) of the implement 12 (e.g., the implement actuator(s) 56, 58, 60, 62 and/or associated control valves), drive device(s) of the vehicle 10 (e.g., the engine 22, the transmission 24, etc.), and/or a user interface(s) (e.g., user interface(s) 224). The user interface(s) 224 described herein may include, without limitation, any combination of input and/or output devices that allow an operator to provide operator inputs to the computing system 202 and/or that allow the computing system 202 to provide feedback to the operator, such as a keyboard, keypad, pointing device, buttons, knobs, touch sensitive screen, mobile device, audio input device, audio output device, and/or the like. Additionally, the computing system 202 may be communicatively coupled to one or more positioning devices 102 configured to generate data indicative of the location of the vehicle 10 and/or the implement 12, such as a satellite navigation positioning device (e.g., a GPS system, a Galileo positioning system, a Global Navigation satellite system (GLONASS), a BeiDou Satellite Navigation and Positioning system, a dead reckoning device, and/or the like).

As will be described in greater detail below, the computing system 202 may be configured to receive data from the soil roughness sensor(s) 100 that is associated with the surface roughness of the field during an agricultural operation being performed by the implement 12. Based on an analysis of the data received from the sensor(s) 100, the computing system 202 may be configured to estimate the surface roughness of the field across the various sections of the field for which surface roughness data was captured. As indicated above, in one embodiment, surface roughness data may be captured by the sensors 100 for the same section of the field both before and after the agricultural operation has been performed. In such an embodiment, the computing system 202 may be configured to analyze the pre-operation and post-operation data to determine a surface roughness differential for the analyzed section of the field. Based on the analysis of the surface roughness data, the computing system 202 may also be configured to perform a control action associated with the work vehicle 10 and/or the implement 12, as necessary, to ensure that the soil surface roughness, in general, and/or the surface roughness differential is maintained at a given target value and/or within a given target range.

In general, the computing system 202 may correspond to any suitable processor-based device(s), such as a computing device or any combination of computing devices. Thus, as shown in FIG. 4, the computing system 202 may generally include one or more processor(s) 204 and associated memory devices 206 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 206 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 206 may generally be configured to store information accessible to the processor(s) 204, including data 208 that can be retrieved, manipulated, created and/or stored by the processor(s) 204 and instructions 116 that can be executed by the processor(s) 204.

In several embodiments, the data 208 may be stored in one or more databases. For example, the data 208 may include a roughness database 212 for storing surface roughness data received from the soil roughness sensor(s) 100. For example, the soil roughness sensor(s) 100 may be configured to continuously or periodically capture surface roughness data of adjacent portion(s) of the field as the agricultural operation is being performed via the implement 12. In such an embodiment, the surface roughness data transmitted to the computing system 202 from the soil roughness sensor(s) 100 may be stored within the roughness database 212 for subsequent processing and/or analysis.

Moreover, in addition to the initial or raw sensor data received from the soil roughness sensor(s) 100, final or post-processing roughness data (as well as any intermediate roughness data created during data processing) may also be stored within the roughness database 212. For example, as will be described below, the computing system 202 may be configured to analyze the data received from the soil roughness sensor(s) 100 using one or more data processing techniques or algorithms to determine surface roughness values for the analyzed portions of the field. In such an embodiment, the processed roughness data and/or the roughness-related data generated during implementation of the data processing techniques or algorithms may be stored within the database 212.

Additionally, in several embodiments, the data 208 may also include a location database 214 storing location information about the work vehicle 10 and/or the implement 12. Specifically, as shown in FIG. 4, the computing system 202 may be communicatively coupled to the positioning device(s) 102 installed on or within the work vehicle 10 and/or on or within the implement 12, where the location determined by the positioning device(s) 102 may be transmitted to the computing system 202 (e.g., in the form of location coordinates) and subsequently stored within the location database 214 for subsequent processing and/or analysis.

In several embodiments, the location data stored within the location database 214 may also be correlated to the surface roughness data stored within the roughness database 212. For instance, in one embodiment, the location coordinates derived from the positioning device(s) 102 and the surface roughness data captured by the sensor(s) 100 may both be time-stamped. In such an embodiment, the time-stamped data may allow each individual set of roughness data captured by the soil roughness sensor(s) 100 to be matched or correlated to a corresponding set of location coordinates received from the positioning device(s) 102, thereby allowing the precise location of the portion of the field associated with a given set of surface roughness data to be known (or at least capable of calculation) by the computing system 202.

Additionally, as shown in FIG. 4, the data 208 may include a field database 216 for storing information related to the field, such as field map data. In such an embodiment, by matching each set of surface roughness data captured by the soil roughness sensor(s) 100 to a corresponding set of location coordinates, the computing system 202 may be configured to generate or update a corresponding field map associated with the field, which may then be stored within the field database 216 for subsequent processing and/or analysis. For example, in instances in which the computing system 202 already includes a field map stored within the field database 216 that includes location coordinates associated with various points across the field, the surface roughness data captured by the soil roughness sensor(s) 100 (e.g., the 3D point cloud) may be mapped or otherwise correlated to the corresponding locations within the field map. Alternatively, based on the location data 214 and the associated sensor data 212, the computing system 202 may be configured to generate a field map that includes the geo-located surface roughness data associated therewith.

Referring still to FIG. 4, in several embodiments, the instructions 210 stored within the memory 206 of the computing system 202 may be executed by the processor(s) 204 to implement a data analysis module 218. In general, the data analysis module 218 may be configured to analyze the initial or raw sensor data captured by the soil roughness sensor(s) 100 to allow the computing system 202 to estimate the surface roughness of one or more sections of the field. For instance, the data analysis module 218 may be configured to execute one or more suitable data processing techniques or algorithms that allows the computing system 202 to accurately and efficiently analyze the sensor data, such as by applying corrections or adjustments to the data based on the sensor type, sensor resolution, and/or other parameters associated with the soil roughness sensor(s) 100, by filtering the data to remove outliers, by implementing sub-routines or intermediate calculations required to estimate the surface roughness of the soil, and/or by performing any other desired data processing-related techniques or algorithms.

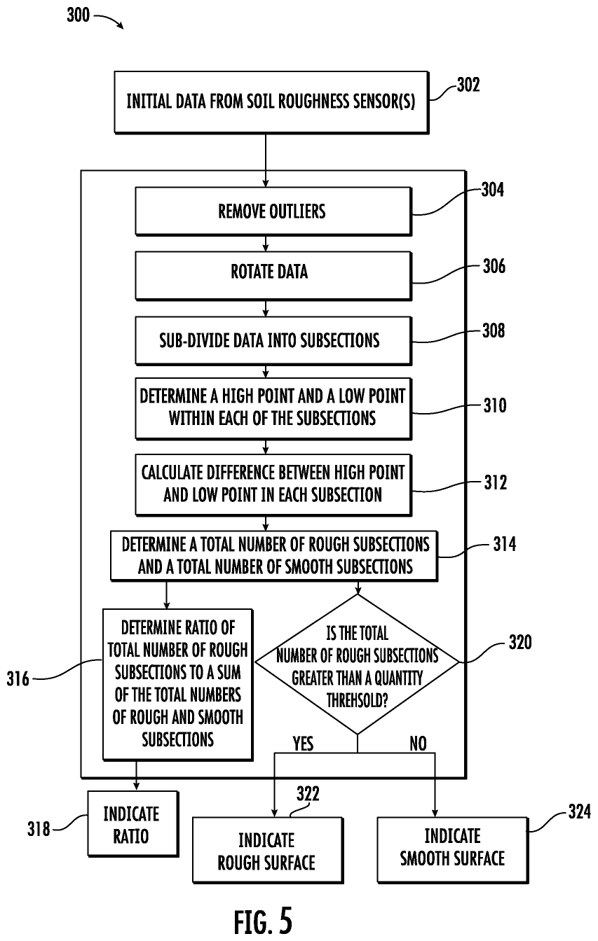

For example, FIG. 5 illustrates a simplified flow diagram 300 showing various data processing steps or elements that may be implemented by the computing system 202 via the data analysis module 218 when analyzing the initial or raw surface roughness data received from the soil roughness sensor(s) 100. It should be appreciated that, although FIG. 5 shows various exemplary data processing steps that can be used to process the initial surface roughness data received from the sensor(s) 100 (e.g., at box 302) and subsequently output final or processed surface roughness determination (e.g., at box 318, box 322, and/or box 324), the data analysis module 218 need not be configured to perform all of the illustrated data processing steps. For instance, in one embodiment, the data analysis module 218 may only perform one of the data processing steps or only a subset of the data processing steps. Additionally, although FIG. 5 depicts data processing steps performed in a particular order for purposes of illustration and discussion, the data flow described herein is not limited to any particular order or arrangement. One skilled in the art, using the disclosure provided herein, will appreciate that various data processing steps disclosed herein can be omitted, rearranged, combined, and/or adapted in various ways without deviating from the scope of the present disclosure.

As shown in FIG. 5, upon receipt of the initial surface roughness data generated by the sensor(s) 100, the data analysis module 218 may, for example, be configured to filter out or remove outliers from the data (e.g., at box 304). Data outliers may, for example, correspond to non-ground-related points captured by the sensor(s) 100, such as dust, flying soil clods, unwanted stubble, and/or the like. In one embodiment, the data analysis module 218 may be configured to implement a machine learning classification algorithm to remove any outliers from the data, such as by implementing decision trees, support vector machines, clustering and/or the like. In this regard, the actual geometry of the surface roughness data, itself, may produce features that can be identified as outliers using any suitable data processing technique. It should be appreciated that similar to the sensor calibration, the specific algorithm or technique used to remove the outliers from the data may be dependent on the type of sensor(s) 100 being used.

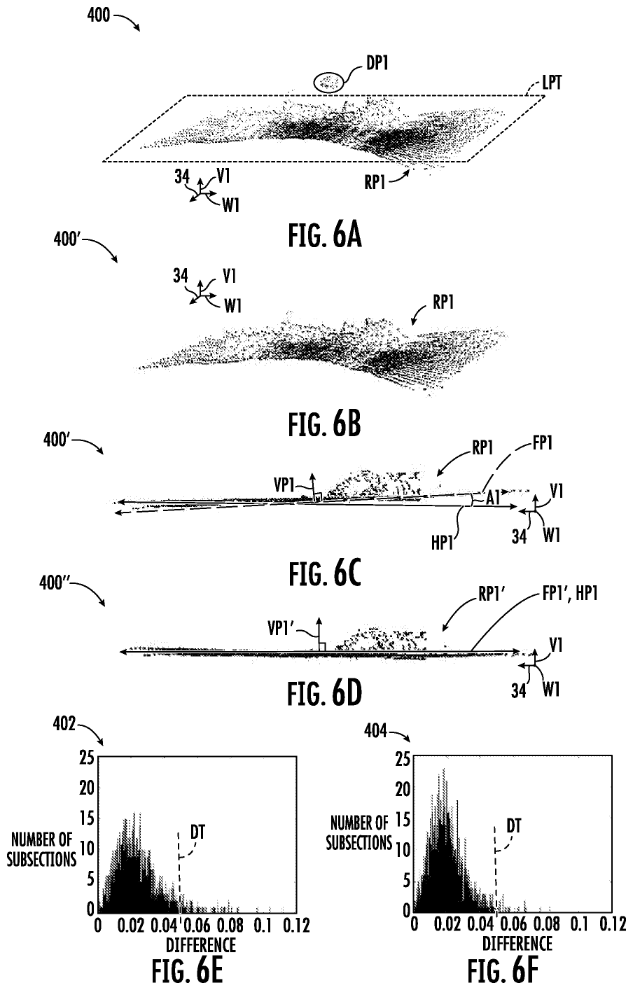

For instance, a LIDAR scanner may produce intensity or reflectivity measurements in connection with the point cloud that may need to be removed as outliers. In such embodiment, the data analysis module 218 may, for instance, apply a simple height filter to the data generated by the sensor(s) 100, in which points of the point cloud that are above a height threshold in a vertical height direction V1 (e.g., closer than a given distance to the sensor(s) 100 and thus, higher than a particular height along the vertical height direction V1) are filtered out from remaining points below such height threshold. For instance, as shown in FIG. 6A, the point cloud 400 formed by the data generated by the sensor(s) 100 may include points DP1 indicative of dust and/or the like which are above a height threshold LPT in the vertical height direction V1 and remaining points RP1 which are below the height threshold LPT in the vertical height direction V1. As such, the data analysis module 218 may filter out the points DP1 to leave only the remaining points RP1 of the filtered point cloud 400′, as shown in FIG. 6B. However, it should be appreciated that any other suitable filtering technique may be used to remove any points not indicative of soil from the remaining points. For example, the data analysis module 218 may additionally, or alternatively, determine a number of neighboring points within a given distance to each of the points of the point cloud generated by the sensor(s) 100. The data analysis module 218 may then filter out points with fewer neighboring points than a given number of neighboring points, where remaining points have at least the given number of neighboring points.

It is noted that, by removing outliers before performing further processing, the surface of the field may be more accurately monitored.

Moreover, as shown in FIG. 5, the data analysis module 218 may rotate the remaining data points (e.g., at box 306). For instance, due to the tillage implement 12 bouncing and/or the like, the sensor(s) 100 may not always be level relative to the surface of the field, which causes the data generated by the sensor(s) 100 to not accurately depict the surface of the field. To counter such issue, the remaining data points RP1 after filtering may be rotated such that an average surface of the field determined from such remaining points RP1 is substantially horizontal. For instance, the instructions 210 associated with the data analysis module 218 may include fitting a plane-of-best-fit to the remaining points RP1, then comparing the plane-of-best-fit to a horizontal plane. If a non-zero angle exists between the plane-of-best-fit and the horizontal plane, then the data analysis module 218 may rotate the data to account for such non-zero angle such that the plane-of-best-fit substantially aligns with the horizontal plane. It should be appreciated that “substantially” means within about 5 degrees, such as within about 3 degrees, and/or the like. However, it should be appreciated that any similar technique may be used to evaluate the orientation of the data. For instance, principal component analysis may be performed to determine a vector of the ground plane from the remaining points.

For example, as shown in FIG. 6C, a plane FP1 fit to the remaining points RP1 of the filtered point cloud 400′ (also referred to as “fitted plane FP1”) is at an angle A1 relative to a horizontal plane HP1, with the horizontal plane HP1 being defined along the direction of travel 34 and lateral direction W1, perpendicular to the vertical direction V1. As such, the fitted plane FP1 has a normal vector VP1, perpendicular to the plane FP1, that is also at the angle A1 relative to the vertical direction V1. The data analysis module 218 may rotate the filtered point cloud 400′ by the angle A1, such that the fitted plane FP1 substantially aligns with the horizontal plane HP1, and that the corresponding vector VP substantially aligns with the vertical direction V1. For example, as shown in FIG. 6D, after the filtered point cloud 400′ is rotated to account for the angle A1 (e.g., by a negative of the angle A1), a fitted plane FP1′ for the rotated, remaining points RP1′ of the rotated point cloud 400″ aligns with the horizontal plane HP1, and the vector VP1′ for such fitted plane FP1′ is aligned with the vertical direction V1.

Referring back to FIG. 5, the data analysis module 218 may sub-divide the data into subsections after rotating the data (e.g., at box 308). For instance, the data analysis module may sub-divide the filtered and rotated point cloud (e.g., point cloud 400″ in FIG. 6D) into subsections along both the direction of travel 34 and the lateral direction W1. As such, each subsection may extend across only part of the length of the point cloud 400″ along the direction of travel 34 and along only part of the width of the point cloud 400″ along the lateral width direction W1, such that multiple sub-sections extend across the length of the point cloud 400″ and multiple sub-sections extend across the width of the point cloud 400″. In some instances, the subsections are equally sized. In one or more instances, a width along the lateral width direction W1 of each subsection may be equal to a length along the direction of travel 34 of each subsection, such that each subsection is substantially square.

The data analysis module 218 may determine both a high point and a low point of the remaining points within each of the subsections (e.g., at box 310). For instance, the data analysis module 218 may determine the high point of the remaining points RP1′ in each of the subsections of the filtered and rotated point cloud 400″, where the high point corresponds to a given high height-percentile of the points within a given subsection. For instance, the high point in a given subsection may have a height that is in about the 95^{th} percentile to about the 100^{th} percentile of the heights of the given subsection, where the 100^{th} percentile is the highest point in the given subsection (closest to the sensor along the vertical direction V1). It should be appreciated that by using a high height-percentile that is less than the 100^{th} percentile, additional points of the remaining points that should have been filtered out as being indicative of dust may be removed. It should additionally be appreciated that, using high height-percentile that is less than the 100^{th} percentile, the initial filtering in step (304) may not be necessary, and a lower percentile (e.g., 80^{th} percentile, and/or the like) may instead be used as the high height-percentile. Similarly, the data analysis module 218 may determine the low point of the remaining points RP1′ in each of the subsections of the filtered and rotated point cloud 400″, where the low point corresponds to a given low height-percentile of the points within a given subsection. For instance, the low point in a given subsection may have a height that is in about the 0^{th} percentile to about the 5^{th} percentile of heights of the given subsection, where the 0^{th} percentile is the lowest point in the given subsection (furthest from the sensor along the vertical direction V1).

It should be appreciated that the given high height-percentile and the given low height-percentile may each be predetermined and stored in the memory 206 of the computing system 202 and/or may be input by a user. In some instances, the given high height-percentile and the given low height-percentile may be selected based at least in part on different field conditions, such as soil type (e.g., % clay, % loam, % silt, % sand, and/or the like), soil moisture, and/or the like.

The data analysis module 218 may then calculate a difference between the high and low points for each of the subsections (e.g., at box 312). For instance, the data analysis module 218 may subtract the height of the low point from the height of the high point in a given subsection to determine the difference for the given subsection and repeat for each of the other subsections. Generally, the larger the difference of a subsection, the rougher the surface roughness for the subsection. Conversely, the smaller the difference of a subsection, the smoother the surface roughness for the subsection.

Moreover, the data analysis module 218 may determine a total number of rough subsections of the plurality of subsections and a total number of smooth subsections (e.g., at box 314). For instance, the difference between the high and low points for a rough subsection is greater than a threshold difference, where the difference between the high and low points for a smooth subsection is less than the threshold difference. In some instances, the difference between the high and low points must be greater than the threshold difference, but less than a maximum difference, to be considered a rough subsection, otherwise, if the difference is greater than both the threshold and maximum differences, the subsection is determined to be invalid, as it likely includes too many points indicative of something other than the field (e.g., dust) and/or the like. The threshold difference DT is generally associated with the transition between a generally rough surface texture and a generally smooth surface texture. It should be appreciated that the threshold difference and the maximum difference may each be predetermined and stored in the memory 206 of the computing system 202 and/or may be input by a user. In some instances, the threshold difference and/or the maximum difference may be selected based at least in part on different field conditions, such as soil type (e.g., % clay, % loam, % silt, % sand, and/or the like), soil moisture, and/or the like.

For example, the plot 402 in FIG. 6E represents a portion of a field having a different surface roughness while the plot 404 in FIG. 6F represents a portion of a field having a smoother surface roughness. More particularly, the plots 402, 404 in FIGS. 6E and 6F show the number of subsections of the plurality of subsections for the respective filtered, rotated, and sub-divided point clouds with respect to different differences between the highest and lowest points within the subsections, and a threshold difference DT (e.g., equal to about 0.05 pixels, which may correspond to about 6 inches). The data analysis module 218 may add the number of sections to the right of the threshold difference DT in each of plots 402, 404 in FIGS. 6E and 6F to determine the total of the number of sections with a difference greater than the threshold difference DT for the plots 402, 404, respectively. For example, the sum of the number of subsections to the right of the threshold difference DT in the plot 402 in FIG. 6E is 100 subsections, whereas the number of subsections to the right of the threshold difference DT in the plot 404 in FIG. 6F is 30 subsections.

The data analysis module 218 may then determine a ratio of the total number of rough subsections to a sum of the total number of rough subsections and the total number of smooth subsections (e.g., at box 316). Such ratio may then be provided to a user as the roughness of the field (e.g., at box 318). For instance, the ratio may be expressed as a percentage (%) roughness, with higher percentages being generally indicative of the portion of the field across the subsections being rougher.

In some instances, the data analysis module 218 may determine whether the total number of rough subsections is greater than a quantity threshold number of subsections (e.g., at box 320). The quantity threshold may be predetermined and stored within the memory 206 of the computing system 202 and/or may be input by a user. In some instances, the quantity threshold may be selected based at least in part on different field conditions, such as soil type (e.g., % clay, % loam, % silt, % sand, and/or the like), soil moisture, and/or the like. In one or more instances, the quantity threshold may be based at least in part on the sum of the total number of rough subsections and the total number of smooth subsections (e.g., the quantity threshold may be about 50% of the sum, such as about 60% of the sum, such as about 70% of the sum, and/or the like). If the total number of subsections with a difference greater than the threshold difference is above or greater than the quantity threshold, the data analysis module 218 may determine that the field has a “rough” surface roughness (e.g., at box 322). 0^{th} erwise, if the total number of subsections with a difference greater than the threshold difference is below or less than the quantity threshold, the data analysis module 218 may determine that the field has a “smooth” surface roughness (e.g., at box 324). For example, the quantity threshold may be 80, where the total number of subsections to the right of the threshold difference DT in FIG. 6E (e.g., 100 subsections) is greater than the quantity threshold, whereas the total number of subsections to the right of the threshold difference DT in FIG. 6F (e.g., 30 subsections) is less than the quantity threshold. As such, the data analysis module 218 may determine that the portion of the field corresponding to FIG. 6E is rough, whereas the portion of the field corresponding to FIG. 6F is smooth. In some instances, there may be multiple quantity thresholds, with each quantity threshold being associated with different degrees of roughness (e.g., smooth, rough, rougher, etc.).

As such, the data analysis module 218 may provide an automatic way to quantify the surface roughness of a field during an agricultural operation.

Referring back to FIG. 4, the instructions stored within the memory 206 of the computing system 202 may also be executed by the processor(s) 204 to implement a control module 220. The control module 220 may generally be configured to initiate or perform a control action associated with the implement 12 based at least in part on the surface roughness of the field determined by the data analysis module 218. For instance, the control module 220 may be configured to monitor the surface roughness of the field determined by the data analysis module 218 relative to a desired surface roughness of the field. The desired surface roughness of the field may be predetermined based on a tillage prescription map, may be input by an operator via a user interface (e.g., user interface 224), or received/accessible in any other suitable manner. The control module 220 may initiate or perform a control action when the monitored surface roughness of the field differs from the desired surface roughness.

The control action, in one embodiment, includes adjusting the operation of one or more components of the implement 12, such as adjusting the operation of one or more of the actuators 56, 58, 60, 62 to adjust the penetration depth and/or aggressiveness of the associated ground engaging tool(s) and/or adjust the operation of one or more of the drive device(s) 22, 24 to adjust a ground speed of the vehicle 10 and/or the implement 12 based on the monitored surface roughness to improve performance of the implement 12. In some embodiments, the control action may include controlling the operation of the user interface(s) 224 to notify an operator of the surface roughness, recommended actions, and/or the like. Additionally, or alternatively, in some embodiments, the control action may include adjusting the operation of the implement 12 based on an input from an operator, e.g., via the user interface 224.

Additionally, as shown in FIG. 4, the computing system 202 may also include a communications interface 222 to provide a means for the computing system 202 to communicate with any of the various other system components described herein. For instance, one or more communicative links or interfaces (e.g., one or more data buses) may be provided between the communications interface 222 and the sensor(s) 100, 102 to allow data transmitted from the sensor(s) 100, 102 to be received by the computing system 202. Similarly, one or more communicative links or interfaces (e.g., one or more data buses) may be provided between the communications interface 222 and the user interface(s) 224 to allow operator inputs to be received by the computing system 202 and to allow the computing system 202 to control the operation of one or more components of the user interface(s) 224. Moreover, one or more communicative links or interfaces (e.g., one or more data buses) may be provided between the communications interface 222 and the implement actuator(s) 56, 58, 60, 62 and/or the drive device(s) 22, 24 to allow the computing system 202 to control the operation of one or more components of the implement actuator(s) 56, 58, 60, 62 and/or the drive device(s) 22, 24.

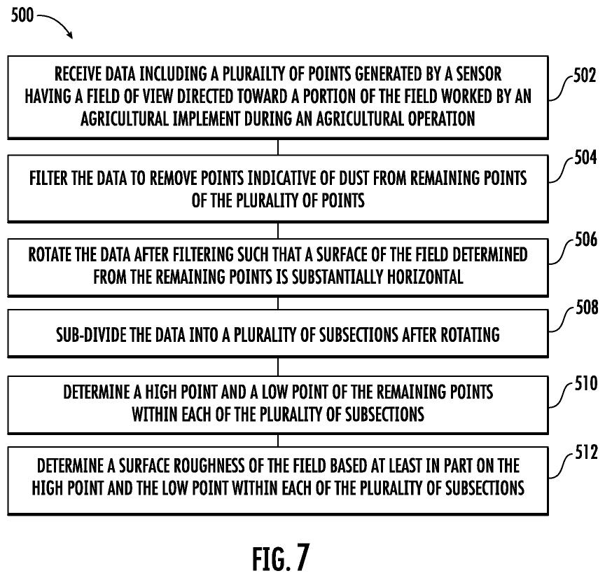

Referring now to FIG. 7, a flow diagram of one embodiment of a method 500 for automatically monitoring the soil surface roughness of a field during the performance an agricultural operation is illustrated in accordance with aspects of the present subject matter. In general, the method 500 will be described herein with reference to the implement 12 and the work vehicle 10 shown in FIGS. 1-3, as well as the various system components shown in FIG. 4, the flow diagram 300 of FIG. 5, and the data in FIGS. 6A-6F. However, it should be appreciated that the disclosed method 500 may be implemented with work vehicles and/or implements having any other suitable configurations, and/or within systems having any other suitable system configurations. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (502), the method 500 may include receiving data including a plurality of data points generated by a sensor having a field of view directed towards a portion of the field worked by an agricultural implement during an agricultural operation. For instance, as described above, the computing system 202 may receive the data generated by the surface roughness sensor(s) 100, configured, in some instances, as a LIDAR sensor(s), where the surface roughness sensor(s) 100 have a field of view directed towards a portion of the field worked by the agricultural implement 12, and where the data includes a 3D point cloud 400 having a plurality of points.

At (504), the method 500 may include filtering the data to remove points indicative of dust from remaining points of the plurality of points. For example, as discussed above, the computing system 202 may filter the data 400 received from the surface roughness sensor(s) 100 to remove data points indicative of dust DP1 from the remaining points RP1. It should be appreciated that “points indicative of dust” is intended to mean any points that are not likely ground surface (e.g., indicative of dust, flying soil clods, and/or the like). For instance, the points indicative of dust DP1 may be above a certain height in the vertical direction V1 (within a certain distance of the sensor(s) 100), have fewer than a given number of neighboring points, and/or the like.

Further, at (506), the method 500 may include rotating the data after filtering such that a surface of the field determined from the remaining points is substantially horizontal. For instance, as discussed above, the computing system 200 may rotate the data 400′ after filtering out the points indicative of dust DP1, such that a ground plane FP1′ determined from the remaining points RP1 is substantially horizontal in the rotated data 400″.

At (508), the method 500 may further include sub-dividing the data into a plurality of subsections after rotating. For example, as described above, the computing system 202 may sub-divide the filtered and rotated data 400″ such that the data 400″ has a plurality of subsections in both the direction of travel 34 and the lateral direction W1.

Moreover, at (510), the method 500 may include determining both a high point and a low point of the remaining points within each of the plurality of subsections. For instance, as described above, the computing system 202 may determine both a high point in the vertical direction V1 and a low point in the vertical direction V1 in each of the plurality of subsections.

Additionally, at (512), the method 500 may include determining a surface roughness of the field based at least in part on the high point and the low point within each of the plurality of subsections. For instance, as discussed above, the computing system 202 may determine whether the surface roughness of the field is smooth or rough based at least in part on the high and low points within each of the subsections of the field. For example, the computing system 202 may count a total number of rough subsections having a difference between the high and low points greater than a threshold difference and a total number of smooth subsections having a difference between the high and low points less than the threshold difference, and determine a ratio of the total number of rough subsections to a sum of the total number of rough and smooth subsections, where the ratio is indicative of an overall roughness of the portion of the field captured in the subsections. Alternatively, or additionally, the computing system 202 may compare the total number of rough subsections to a quantity threshold associated with a rough surface roughness, where the portion of the field is rough when the total number of rough subsections is greater than the quantity threshold.

It is to be understood that the steps of the method 500 are performed by the computing system 202 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 202 described herein, such as the method 500, is implemented in software code or instructions which are tangibly stored on a tangible computer readable medium. The computing system 202 loads the software code or instructions via a direct interface with the computer readable medium or via a wired and/or wireless network. Upon loading and executing such software code or instructions by the computing system 202, the computing system 202 may perform any of the functionality of the computing system 202 described herein, including any steps of the method 500 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural system for monitoring surface roughness within a field during an agricultural operation, the agricultural system comprising:
an agricultural implement having at least one ground engaging tool, the at least one ground engaging tool being configured to engage a field to perform an agricultural operation within the field as the agricultural implement moves across the field;
a sensor having a field of view directed toward a portion of the field worked by the agricultural implement during the agricultural operation, the sensor being configured to generate data indicative of the portion of the field, the data including a plurality of points; and
a computing system configured to:
receive the data generated by the sensor;
filter the data to remove points indicative of dust from remaining points of the plurality of points;
rotate the data after filtering such that a surface of the field determined from the remaining points is substantially horizontal;
sub-divide the data into a plurality of subsections after rotating;
determine both a high point associated with a given high height-percentile and a low point associated with a given low height-percentile of the remaining points within each of the plurality of subsections, the given high height-percentile being higher than the given low height-percentile; and
determine a surface roughness of the field based at least in part on the high point and the low point within each of the plurality of subsections.

2. The agricultural system of claim 1, wherein the computing system is configured to filter the data by applying a height filter to the data, the height filter having a height threshold, the points indicative of dust being above the height threshold and the remaining points being below the height threshold.

3. The agricultural system of claim 1, wherein the computing system is configured to filter the data by identifying neighboring points of the plurality of points within a certain distance for each of the plurality of points, a number of the neighboring points for each of the points indicative of dust being less than a threshold number, a number of the neighboring points for each of the remaining points being above the threshold number.

4. The agricultural system of claim 1, wherein the computing system is configured to rotate the data after filtering by:
fitting a plane to the remaining points;
determining an angle between the plane and a horizontal plane; and
rotating the plane based at least in part on the angle.

5. The agricultural system of claim 1, wherein the computing system is configured to sub-divide the data along both a direction of travel of the agricultural implement and along a lateral direction of the agricultural implement into the plurality of subsections.

6. The agricultural system of claim 1, wherein the plurality of subsections are equally sized.

7. The agricultural system of claim 1, wherein the computing system is configured to determine the surface roughness of the field by:
determining a total number of rough subsections of the plurality of subsections having a difference between a height of the high point and a height of the low point greater than a threshold difference;
determining a total number of smooth subsections of the plurality of subsections having a difference between the height of the high point and the height of the low point less than the threshold difference;
determining a ratio between the total number of rough subsections and a sum of the total number of rough subsections and the total number of smooth subsections, the ratio being the surface roughness of the field.

8. The agricultural system of claim 1, wherein the high height-percentile is from about a 95^{th} height-percentile to about a 100^{th} height-percentile, wherein the low height-percentile is from about a 0^{th} height-percentile to about a 5^{th} height-percentile.

9. The agricultural system of claim 1, wherein the sensor is a Light Detection and Ranging (LIDAR) sensor.

10. The agricultural system of claim 1, wherein the at least one ground engaging tool comprises at least one of a shank, a disk blade, leveling blades, or a basket assembly.

11. An agricultural method for monitoring surface roughness within a field during an agricultural operation with an agricultural implement having at least one ground engaging tool, the at least one ground engaging tool being configured to engage the field to perform the agricultural operation as the agricultural implement moves across the field, the agricultural method comprising:
receiving, with a computing system, data generated by a sensor having a field of view directed toward a portion of the field worked by the agricultural implement during the agricultural operation, the data being indicative of the portion of the field, the data including a plurality of points;
filtering, with the computing system, the data to remove points indicative of dust from remaining points of the plurality of points;
rotating, with the computing system, the data after filtering such that a surface of the field determined from the remaining points is substantially horizontal;
sub-dividing, with the computing system, the data into a plurality of subsections after rotating;
determining, with the computing system, both a high point associated with a given high height-percentile and a low point associated with a given low height-percentile of the remaining points within each of the plurality of subsections, the given high height-percentile being higher than the given low height-percentile;
determining, with the computing system, a surface roughness of the field based at least in part on the high point and the low point within each of the plurality of subsections; and
performing, with the computing system, a control action associated with the agricultural implement based at least in part on the surface roughness of the field.

12. The agricultural method of claim 11, wherein filtering the data comprises applying a height filter to the data, the height filter having a height threshold, the points indicative of dust being above the height threshold and the remaining points being below the height threshold.

13. The agricultural method of claim 11, wherein filtering the data comprises identifying neighboring points of the plurality of points within a certain distance for each of the plurality of points, a number of the neighboring points for each of the points indicative of dust being less than a threshold number, a number of the neighboring points for each of the remaining points being above the threshold number.

14. The agricultural method of claim 11, wherein rotating the data after filtering comprises:
fitting a plane to the remaining points;
determining an angle between the plane and a horizontal plane; and
rotating the plane based at least in part on the angle.

15. The agricultural method of claim 11, wherein sub-dividing the data comprises sub-dividing the data along both a direction of travel of the agricultural implement and along a lateral direction of the agricultural implement into the plurality of subsections.

16. The agricultural method of claim 11, wherein the plurality of subsections are equally sized.

17. The agricultural method of claim 11, wherein determining the surface roughness of the field comprises:
determining, with the computing system, a total number of rough subsections of the plurality of subsections having a difference between a height of the high point and a height of the low point greater than a threshold difference;
determining, with the computing system, a total number of smooth subsections of the plurality of subsections having a difference between the height of the high point and the height of the low point less than the threshold difference;
determining, with the computing system, a ratio between the total number of rough subsections and a sum of the total number of rough subsections and the total number of smooth subsections.

18. The agricultural method of claim 11, wherein the high height-percentile is from about a 95^{th} height-percentile to about a 100^{th} height-percentile, wherein the low height-percentile is from about a 0^{th} height-percentile to about a 5^{th} height-percentile.

19. The agricultural method of claim 11, wherein performing the control action comprises controlling an operation of the agricultural implement based at least in part on the surface roughness of the field.

20. The agricultural method of claim 11, wherein performing the control action comprises controlling an operation of a user interface associated with the agricultural implement to indicate the surface roughness of the field.
